(19) United States
(12) Patent Application Publication
(10) Pub. No.: US 2025/0367955 A1
(43) Pub. Date: Dec. 4, 2025

(54) PRINTER

(71) Applicant: BROTHER KOGYO KABUSHIKI KAISHA, Nagoya (JP)

(72) Inventors: Guowei CHAI, Nagoya (JP); Atsushi FUJIOKA, Nagoya (JP)

(21) Appl. No.: 19/219,637

(22) Filed: May 27, 2025

(30) Foreign Application Priority Data
May 28, 2024 (JP) 2024-085983
Apr. 17, 2025 (JP) 2025-067958

(51) Int. Cl. B41J 29/393; B41J 2/32; B41J 11/04; B41J 15/04; B41J 29/377

(52) U.S. Cl. CPC B41J 29/393; B41J 11/04; B41J 15/048; B41J 29/377; B41J 2/32

(57) ABSTRACT

A printer includes a transport roller, a transport motor, a motor driver, a print head, a first temperature sensor, a power reception/delivery control component, a second temperature sensor, and a processor. The first temperature sensor is configured to detect a motor temperature corresponding to a temperature of the transport motor, the motor driver, or both the transport motor and the motor driver. The second temperature sensor is configured to detect a component temperature corresponding to a temperature of the power reception/delivery control component. The processor is configured to execute driving the transport motor and the print head to perform printing on a medium, and reducing a rotation speed of the transport motor during the printing, based on at least the motor temperature and the component temperature, to reduce a rise in the motor temperature.

### REFERENCE TO RELATED APPLICATIONS

This application claims priority from Japanese Patent Application No. 2024-085983 filed on May 28, 2024, and Japanese Patent Application No. 2025-067958 filed on Apr. 17, 2025. The entire content of the priority applications is incorporated herein by reference.

### BACKGROUND ART

A known printer includes a platen roller that transports roll paper, a transport motor that drives the platen roller, and a thermal line head that prints the roll paper. In a case where a motor temperature of the transport motor reaches a forced cooling temperature during the printing, the printer performs cooling control that immediately stops the driving of the thermal head and the transport motor. After the motor temperature has fallen to a forced cooling cancellation temperature, the printer forms dots overlapping a print line on which dots have been formed last, and re-starts print processing. In a case where the motor temperature reaches a between-page cooling temperature in a state in which the thermal line head faces a non-printing region, the printer performs cooling control that stops the transport in the state in which the thermal line head is facing the non-printing region. The printer re-starts the print processing in a case where the motor temperature has fallen to a cooling cancellation temperature.

### SUMMARY

In a case where a printer includes a power reception/delivery control component that performs at least one of power reception or power delivery, and the printer performs at least one of the power reception or power delivery using the power reception/delivery control component, heat generated from the power reception/delivery control component is transmitted to a temperature sensor of a transport motor, and there is a possibility that cooling control cannot be appropriately performed.

Embodiments of the broad principles derived herein provide a printer that contributes to appropriately executing temperature control of a transport motor that transports a medium, even when heat is generated as a result of using a power reception/delivery control component.

Embodiments provide a printer that includes a transport roller, a transport motor, a motor driver, a print head, a first temperature sensor, a power reception/delivery control component, a second temperature sensor, and a processor. The transport motor is configured to drive the transport roller. The motor driver is configured to drive the transport motor. The first temperature sensor is configured to detect a motor temperature corresponding to a temperature of the transport motor, the motor driver, or both the transport motor and the motor driver. The power reception/delivery control component is configured to execute power reception, power delivery, or both power reception and power delivery. The second temperature sensor is configured to detect a component temperature corresponding to a temperature of the power reception/delivery control component. The processor is configured to execute driving the transport motor and the print head to perform printing on a medium, and reducing a rotation speed of the transport motor during the printing, based on at least the motor temperature and the component temperature, to reduce a rise in the motor temperature. The printer reduces the rotation speed of the transport motor during the printing based on at least the motor temperature and the component temperature. Thus, compared to a printer of related art that controls the rotation speed of the transport motor without basing the control on the component temperature, the printer contributes to appropriately executing temperature control of the transport motor, even when heat is generated as a result of using the power reception/delivery control component.

Embodiments further provide a printer that includes a transport roller, a transport motor, a motor driver, a print head, a first temperature sensor, a power reception/delivery control component, and a processor. The transport motor is configured to drive the transport roller. The motor driver is configured to drive the transport motor. The first temperature sensor is configured to detect a motor temperature. The motor temperature is a temperature having a correlation with a temperature of the transport motor or the motor driver, or with a temperature of both the transport motor and the motor driver. The power reception/delivery control component is configured to execute power reception, power delivery, or both power reception and power delivery. The processor is configured to execute driving the transport motor and the print head to perform printing on a medium, and decelerating or stopping the transport motor during the printing, in a case where a value obtained by subtracting a correction value and a control threshold value from the motor temperature is greater than zero, to reduce a rise in the motor temperature, the correction value corresponding to whether it is a component driving time. The component driving time is a time at which the power reception/delivery control component is performing the power reception or the power delivery with an external device. The correction value is the value corresponding to whether it is the component driving time at which the power reception/delivery control component is executing the power reception or the power delivery with the external device. Compared to a case of the known printer that controls the transport motor without using the correction value, the motor control processing of the printer contributes to appropriately executing the temperature control of the transport motor while taking into consideration the heat generated by the use of the power reception/delivery control component.

### BRIEF DESCRIPTION OF DRAWINGS

FIG. 1 is a perspective view of a printer, as seen from the front right and above, when a cover is closed.

FIG. 2 is a perspective view of the printer, as seen from the front right and above, when the cover is open.

FIG. 3 is a cross-sectional view seen in the direction of arrows along a line 3-3 shown in FIG. 1.

FIG. 4 is a perspective view of a first substrate.

FIG. 5 is a block diagram showing an electrical configuration of the printer.

FIG. 6 is a flowchart of main processing.

FIG. 7 illustrates a table referred to in the main processing.

FIG. 8 is a block diagram showing an electrical configuration of the printer.

FIG. 9 is a flowchart of main processing.

FIG. 10 illustrates a table referred to in the main processing.

FIG. 11A and FIG. 11B are graphs referred to in the main processing.

### DESCRIPTION

An embodiment of the present disclosure will be described below with reference to the accompanying drawings. The referenced drawings are used to describe technological features that can be adopted by the present disclosure. In other words, configurations, for example, shown in the drawings are not limited to those configurations only, and are simply explanatory examples.

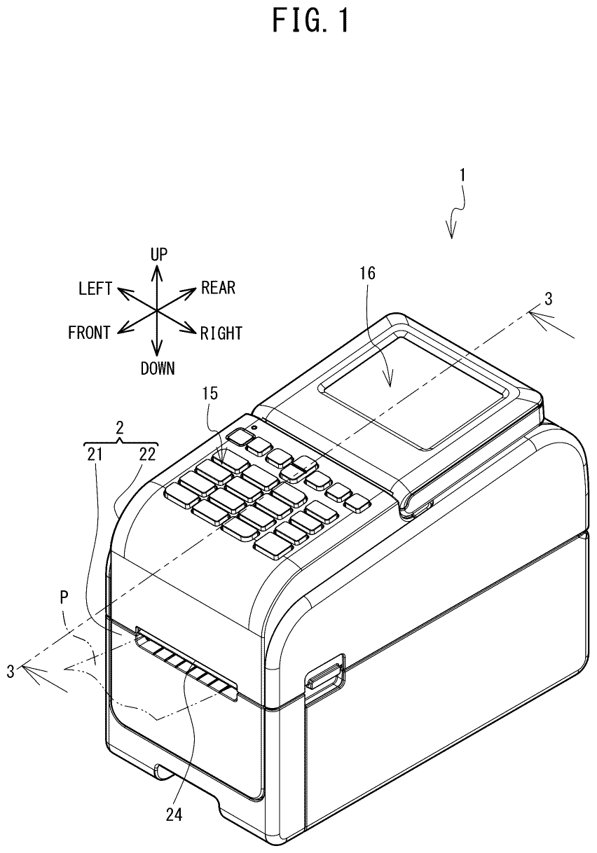

A physical configuration of a printer 1 will be described with reference to FIG. 1 to FIG. 4. Hereinafter, an upper left direction, a lower right direction, a lower left direction, an upper right direction, an upward direction, and a downward direction are, respectively, a left direction, a right direction, a forward direction, a rear direction, an upward direction, and a downward direction of the printer 1. Note that, in the present embodiment, the up-down direction is used for the purpose of explanation, for example, and is not limited to the vertical direction.

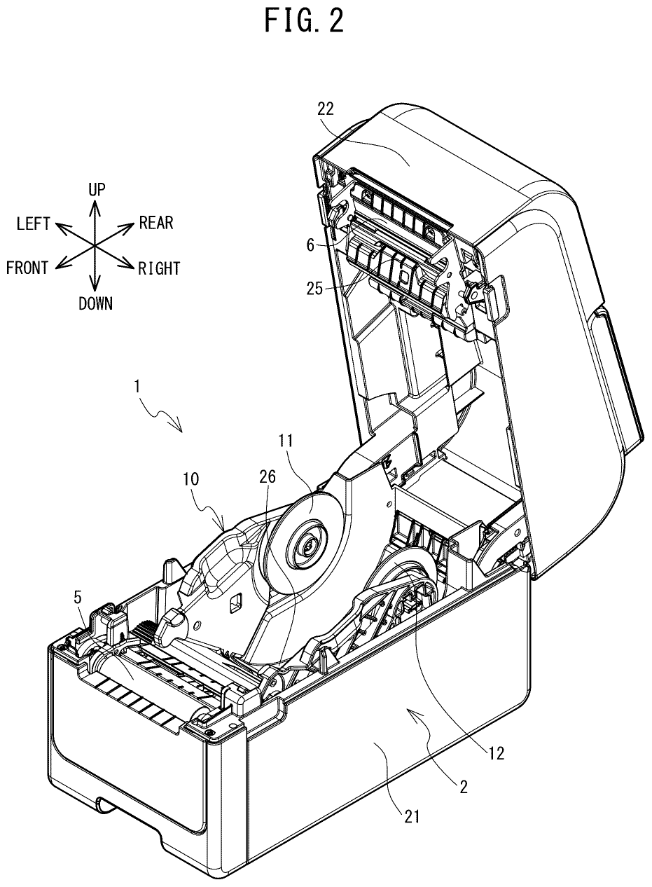

As shown in FIG. 1 and FIG. 2, the printer 1 is a thermal printer configured to perform printing on a medium P. The medium P according to the present embodiment is a long print tape. A length of the medium P in a transport direction is longer than a length of the medium P in a width direction. The width direction is a left-right direction, and the transport direction is a front-rear direction. The printer 1 includes a housing 2, an input interface 15, and a display 16. The housing 2 includes a main body portion 21, a cover 22, a storage plate 26, and an intermediate plate 27. The main body portion 21 is a substantially cuboid box shape extending in the front-rear direction, and is a lower portion of the housing 2. The main body portion 21 is open in the upward direction. The cover 22 is a substantially cuboid box shape extending in the front-rear direction, and is an upper portion of the housing 2. The cover 22 is configured to rotate about a shaft center extending in the left-right direction at a rear upper end of the main body portion 21. FIG. 1 shows a state in which the cover 22 is closed, and the cover 22 covers the opening of the main body portion 21 in the upward direction. FIG. 2 shows a state in which the cover 22 is open, and the cover 22 opens the opening of the main body portion 21 in the upward direction.

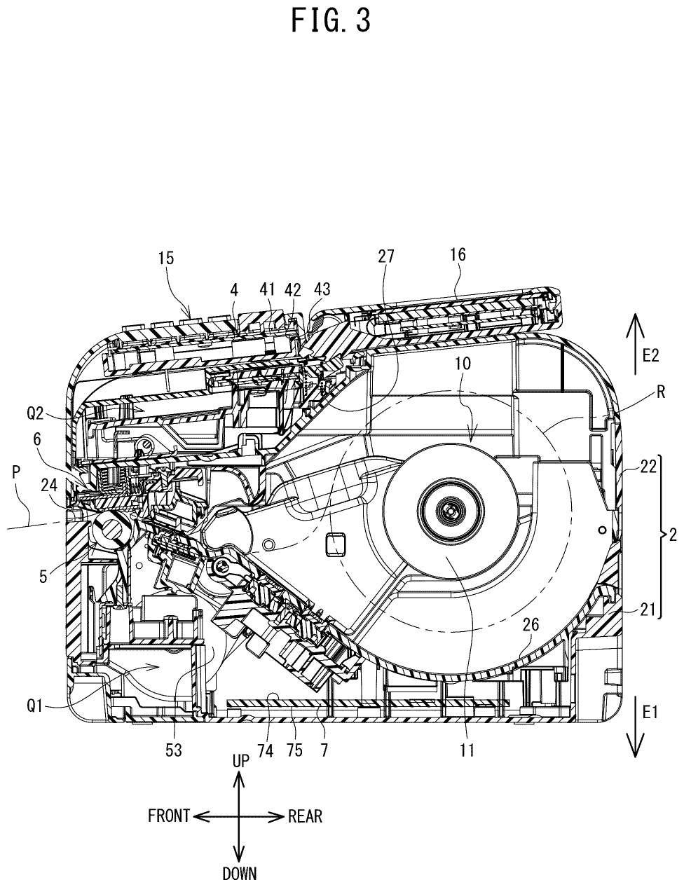

As shown in FIG. 3, the storage plate 26 is plate-shaped, extending in a circular arc shape from the vicinity of a rear end upper portion of the main body portion 21 so as to bulge downward the further toward the front, and subsequently extending in a straight line to the vicinity of the rear of a transport roller 5 to be described later. The storage plate 26 extends in the left-right direction from the left end to the right end of an inner side surface of the main body portion 21.

The intermediate plate 27 extends from the vicinity of the front end of the display 16 of the inner side surface of the cover 22, first extending downward the further toward the front and subsequently extending to the front to the vicinity of the front end portion of the cover 22. The intermediate plate 27 extends in the left-right direction from the left end to the right end of the inner side surface of the cover 22. The intermediate plate 27 is positioned below the cover 22 and above the storage plate 26 in the up-down direction.

A discharge opening 24 is located in the front end of the housing 2. The discharge opening 24 is a gap between the front wall of the main body portion 21 and the front wall of the cover 22, and extends in the left-right direction. The printed medium P is discharged from the housing 2 via the discharge opening 24.

As shown in FIG. 1, the input interface 15 and the display 16 are located at the upper end portion of the cover 22. The input interface 15 is configured to receive the input of various information, and various commands, for example, and is a switch configured to output to a CPU 30 to be described later. The display 16 is configured to display various screens, based on an input from the CPU 30.

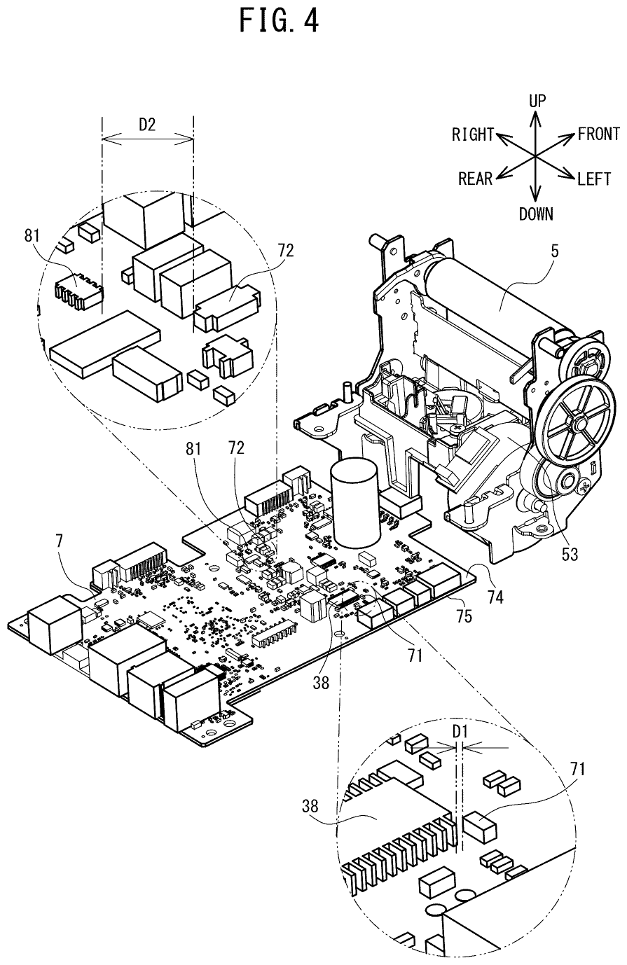

As shown in FIG. 2 and FIG. 4, inside the housing 2, the printer 1 includes a support mechanism 10, the transport roller 5, a transport motor 53, a motor driver 38, a first substrate 7, a first temperature sensor 71, a power reception/delivery control component 81, a second temperature sensor 72, a mounting portion 25, a print head 6, a second substrate 4, and a third temperature sensor 41.

The support mechanism 10 is configured to support a roll R around which the medium P is wound. The rear end of the support mechanism 10 is at substantially the same position as the rear end of the main body portion 21. The front end of the support mechanism 10 is disposed between the front end of the main body portion 21 and a central portion of the main body portion 21 in the front-rear direction. The support mechanism 10 includes a left support portion 11 and a right support portion 12. The left support portion 11 is configured to support the left portion of the roll R. The right support portion 12 is positioned further to the right than the left support portion 11, and is configured to support the right portion of the roll R.

The transport roller 5 is located at the upper front end of the main body portion 21. The transport roller 5 is disposed between the front end of the main body portion 21 and the front end of the support mechanism 10 in the front-rear direction. The transport roller 5 is a circular cylinder having a shaft center extending in the left-right direction, and is located at the main body portion 21 so as to be able to rotate about the shaft center. The transport motor 53 is located below and to the rear of the left end of the transport roller 5. The transport motor 53 is configured to drive the transport roller 5. The transport roller 5 is rotated by the driving of the transport motor 53 to transport the medium P in the forward direction. The motor driver 38 is configured to drive the transport motor 53.

As shown in FIG. 3, the first substrate 7 has a plate shape that spreads in a direction perpendicular to the up-down direction. Largest surfaces of the first substrate 7 are an upper surface 74 and a lower surface 75. Inside the main body portion 21, the first substrate 7 is disposed at a position lower than and further to the rear than the transport roller 5 and the transport motor 53. In a direction perpendicular to the largest surface of the first substrate 7, namely, a direction perpendicular to the upper surface 74, the first substrate 7 is disposed in a first direction E1 in relation to the print head 6. The first direction E1 in the present embodiment is the downward direction, and is a direction from the print head 6 toward the transport roller 5. The first substrate 7 is disposed in a space Q1 encompassed by the main body portion 21 and the storage plate 26.

As shown in FIG. 4, the motor driver 38, the first temperature sensor 71, the power reception/delivery control component 81, and the second temperature sensor 72 are mounted on the first substrate 7. The first temperature sensor 71 is configured to detect a motor temperature T1 corresponding to the temperature of the transport motor 53, the motor driver 38, or the transport motor 53 and the motor driver 38. In other words, the motor temperature T1 is the temperature having a correlation with the temperature of the transport motor 53 or the motor driver 38, or with both the transport motor 53 and the motor driver 38. “The temperature having a correlation with” in the present specification refers to a temperature that satisfies the following two conditions. The first condition is a condition that, when the temperature of a component rises or falls, the temperature detected by the temperature sensor at the position at which the temperature sensor is located also changes with the same tendency. The second condition is a condition that the temperature is a temperature for which correlationality of the changes in the temperature has statistical significance. The first temperature sensor 71 according to the present embodiment is configured to detect the motor temperature T1 corresponding to the temperature of the motor driver 38. The first temperature sensor 71 is a thermistor, and, in order to favorably detect the motor temperature T1, is preferably located in the vicinity of the motor driver 38. More specifically, a first distance D1 between the first temperature sensor 71 and the motor driver 38 is preferably 10 mm or less, and is more preferably 5 mm or less. The first temperature sensor 71 according to the present embodiment is disposed at a first position at which the distance between first temperature sensor 71 and the transport motor 53 or the motor driver 38 is 10 mm or less. The first temperature sensor 71 is configured to detect the temperature detected at the first position as the motor temperature T1.

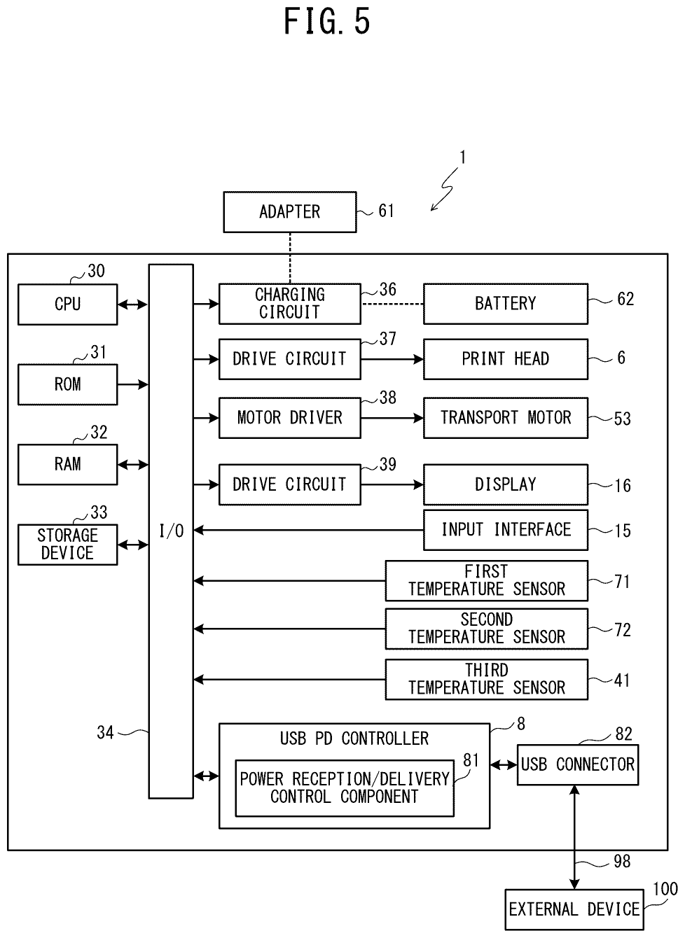

The power reception/delivery control component 81 is configured to execute power reception, power delivery, or both power reception and power delivery with an external device 100. The power reception/delivery control component 81 is, for example, at least one selected from a group of a DCDC converter, a charging circuit, and an inductor. As shown in FIG. 5, the printer 1 according to the present embodiment includes a USB connector 82 that connects to the external device 100 using a connection compatible with universal serial bus power delivery (USB PD), and with a USB PD controller 8. The printer 1 is configured to supply power to the external device 100 via the USB connector 82. The USB PD controller 8 according to the present embodiment includes a DCDC converter as the power reception/delivery control component 81.

The second temperature sensor 72 is configured to detect a component temperature T2 corresponding to the temperature of the power reception/delivery control component 81. The second temperature sensor 72 is a thermistor, and, in order to favorably detect the component temperature T2, is preferably located in the vicinity of the power reception/delivery control component 81. More specifically, a distance D2 between the second temperature sensor 72 and the power reception/delivery control component 81 is preferably 10 mm or less, and is more preferably 5 mm or less. The second temperature sensor 72 according to the present embodiment is disposed at a second position at which the distance between the second temperature sensor 72 and the power reception/delivery control component 81 is 10 mm or less. The second temperature sensor 72 is configured to detect the temperature detected at the second position as the component temperature T2 corresponding to the temperature of the power reception/delivery control component 81.

The mounting portion 25 is located at the lower end of the cover 22. The print head 6 is configured to be removably mounted to the mounting portion 25. The print head 6 is configured to print the medium P. The print head 6 has a plate shape extending in the left-right direction, and is mounted to the mounting portion 25 from below. The print head 6 according to the present embodiment is a thermal head including a plurality of heating elements. The printer 1 is configured to perform the printing on the medium P by selectively heating the plurality of heating elements of the print head 6.

The second substrate 4 has a plate shape that spreads in a direction intersecting the up-down direction. Largest surfaces of the second substrate 4 are an upper surface 42 and a lower surface 43. Inside the cover 22, the second substrate 4 is disposed at a position higher than the print head 6, and lower than the input interface 15. In a direction perpendicular to the largest surface of the first substrate 7, namely, the upper surface 74, the second substrate 4 is disposed in a second direction E2 in relation to the print head 6. The second direction E2 is a direction opposite to the first direction E1. The second direction E2 of the present embodiment is the upward direction, and is a direction from the transport roller 5 toward the print head 6. The second substrate 4 is disposed in a space Q2 encompassed by the cover 22 and the intermediate plate 27. The space Q1 and the space Q2 are separated from each other by the storage plate 26 and the intermediate plate 27, and are not connected with each other. The third temperature sensor 41 is mounted on the second substrate 4 that is different from the first substrate 7, and is configured to detect an ambient temperature T3 corresponding to the temperature of the surrounding atmosphere of the printer 1. In order to appropriately detect the ambient temperature T3, the third temperature sensor 41 according to the present embodiment is located at a position separated from the print head 6, the power reception/delivery control component 81, the transport motor 53, and the motor driver 38. The ambient temperature T3 detected by the third temperature sensor 41 according to the present embodiment is substantially the same as a room temperature in the location at which the printer 1 is disposed. The third temperature sensor 41 is disposed at a third position at which a second distance between the third temperature sensor 41 and a motor-related component is greater than the first distance D1. The second distance between the third temperature sensor 41 and a motor-related component is substantially the same as a distance between the first substrate 7 and the second substrate 4. The motor-related component is the transport motor 53 or the motor driver 38. The motor-related component according to the present embodiment is the motor driver 38. The third temperature sensor 41 is configured to detect the temperature detected at the third position as the ambient temperature T3.

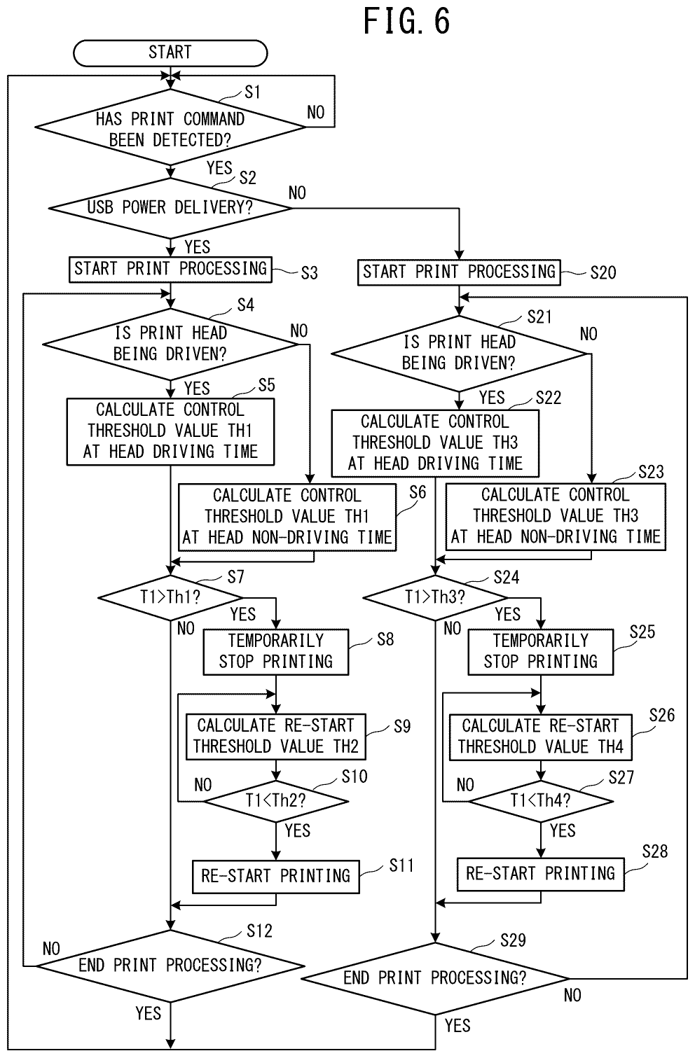

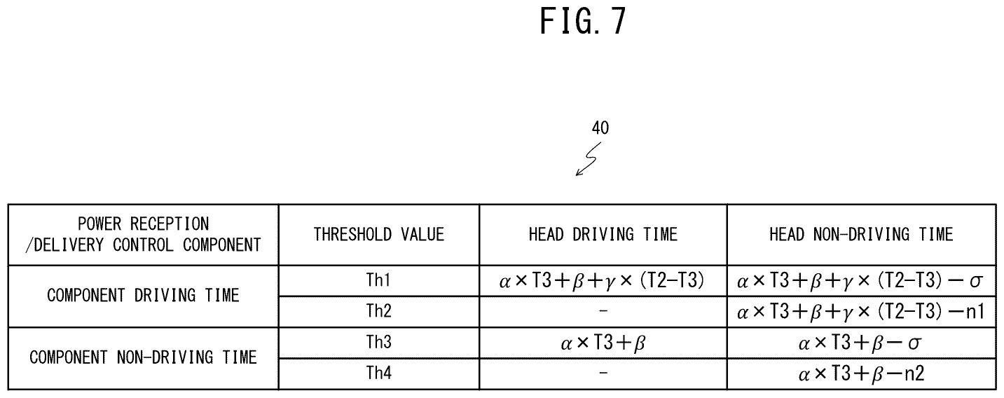

The electrical configuration of the printer 1 will be described with reference to FIG. 5. The printer 1 includes the CPU 30, a ROM 31, a RAM 32, a storage device 33, and an input/output interface (I/O) 34. The CPU 30, the ROM 31, the RAM 32, and the storage device 33 are electrically connected to the I/O 34. The CPU 30 is a processor that is configured to control the printer 1. The ROM 31 stores various setting information. The RAM 32 is configured to temporarily store various information. The storage device 33 is non-volatile, and stores a program for executing main processing shown in FIG. 6, a table 40 shown in FIG. 7 that is referred to in the main processing, for example. The table 40 will be described later.

A charging circuit 36, drive circuits 37 and 39, the motor driver 38, the input interface 15, the first temperature sensor 71, the second temperature sensor 72, the third temperature sensor 41, and the USB PD (power delivery) controller 8 are connected to the I/O 34. The charging circuit 36 is configured to be electrically connected to an adapter 61, and a battery 62, and is an electronic circuit for controlling charging of the battery 62. The battery 62 is a lithium ion battery or an electric double layer capacitor, for example. The drive circuit 37 is configured to control driving of the print head 6 in accordance with a command input from the CPU 30. The drive circuit 39 is configured to control driving of the display 16 in accordance with a command input from the CPU 30. The input interface 15, the first temperature sensor 71, the second temperature sensor 72, and the third temperature sensor 41 are configured to input detection results to the I/O 34.

The USB PD controller 8 is configured to perform communication with the external device 100, in accordance with a control command output by the CPU 30. The USB PD controller 8 is connected to the USB connector 82. The USB connector 82 is a connection port for connecting to the external device 100, via a cable 98 that conforms to the USB PD standard. The external device 100 is a USB device.

A printing operation by the printer 1 will be described. A user operates the input interface 15, and inputs a print command to the printer 1. In a case where the CPU 30 detects the print command, the CPU 30 outputs a control signal to the motor driver 38. The motor driver 38 is configured to drive the transport motor 53 by outputting a drive current that accords with the control signal received from the CPU 30 to rotate the transport roller. In this way, the medium P is pulled out from the roll R. The printer 1 is configured to output a control signal to the drive circuit 37. The drive circuit 37 is configured to control the print head 6 to selectively heat the plurality of heating elements. A section of the medium P heated by the heating elements develops color. The printer 1 is configured to repeat the transport of the medium P by a predetermined amount by the transport roller 5, and the selective heating by the print head 6. As a result, the printing is performed on the medium P. The printed medium P is discharged to the outside of the housing 2 via the discharge opening 24.

An overview of the table 40 and main processing will be described with reference to FIG. 7. The table 40 stores calculation formulas for calculating control threshold values Th1 and Th3, and re-start threshold values Th2 and Th4. The control threshold values Th1 and Th3 are threshold values used in determining whether to perform motor control processing. In the motor control processing, in order to reduce overheating of the transport motor 53, a rotation speed of the transport motor 53 is lowered during execution of the print processing, and a rise in the motor temperature T1 is reduced. The re-start threshold values Th2 and Th4 are threshold values used in determining whether to start processing to raise the rotation speed, after lowering the rotation speed of the transport motor 53 during the execution of the print processing in the motor control processing. In the table 40, each of a, B, Y, and o is a parameter for estimating the motor temperature T1. n1 is a parameter for calculating the re-start threshold value Th2. n2 is a parameter for calculating the re-start threshold value Th4.

The CPU 30 according to the present embodiment determines the control threshold value Th3 at a component non-driving time and the control threshold value Th1 at a component driving time, as mutually different values. “The component non-driving time” refers to a time at which the power reception/delivery control component 81 is not performing power reception and power delivery with the external device 100. “The component driving time” refers to a time at which the power reception/delivery control component 81 is performing the power reception and power delivery with the external device 100.

In the printer 1 according to the present embodiment, in a case where at least one of the power reception or the power delivery is performed using the power reception/delivery control component 81, the heat generated from the power reception/delivery control component 81 is transmitted to the surrounding atmosphere of the first temperature sensor 71. Thus, the CPU 30 determines the control threshold value Th1 during the execution of the print processing based on at least the component temperature T2. More specifically, the CPU 30 determines the control threshold value Th1 based on at least the component temperature T2 and the ambient temperature T3. Even more specifically, the CPU 30 determines the control threshold value Th1 based on a temperature difference obtained by subtracting the ambient temperature T3 from the component temperature T2.

Furthermore, the CPU 30 according to the present embodiment determines the control threshold value Th1 at a head non-driving time and the control threshold value Th1 at a head driving time, as mutually different values. “The head non-driving time” refers to a time at which the print head 6 is not being driven. “The head driving time” refers to a time at which the print head 6 is being driven. The CPU 30 according to the present embodiment determines the control threshold value Th3 at the head non-driving time and the control threshold value Th3 at the head driving time, as the mutually different values. Thus, in the table 40, four types of control threshold value are stored, namely, the control threshold value Th3 at the head driving time and the component non-driving time, the control threshold value Th3 at the head non-driving time and the component non-driving time, the control threshold value Th1 at the head driving time and the component driving time, and the control threshold value Th1 at the head non-driving time and the component driving time. On the other hand, in the table 40, two types of the re-start threshold value are stored, namely, the re-start threshold values Th2 and Th4.

The main processing executed by the printer 1 will be described with reference to FIG. 6 and FIG. 7. Hereinafter, “step” will be abbreviated as “S”. After a power source is turned ON, the CPU 30 reads out, to the RAM 32, the program stored in the ROM 31. The program includes instructions for the CPU 31 to perform the following processes. In accordance with instructions included in the program read out to the RAM 32, the CPU 30 executes the main processing that includes the following steps. Various data obtained in the course of the main processing are stored in the RAM 32 as appropriate.

The CPU 30 determines whether the print command has been detected (S1). Print data representing a print image are included in the print command. In a case where the print command has not been detected (no at S1), the CPU 30 returns the processing to S1. In a case where the print command has been detected (yes at S1), the CPU 30 determines whether it is the component driving time, which is the time at which the power reception/delivery control component 81 is performing the power reception or power delivery with the external device 100 (S2). In a case where it is the component driving time (yes at S2), the CPU 30 outputs a control signal to the motor driver 38 and the drive circuit 37. The CPU 30 drives the transport motor 53 and the print head 6 in accordance with the print data included in the print command acquired at S1 to start the print processing of printing the print image on the medium P (S3). The printer 1 repeats the transport of the medium P by the predetermined amount by the transport roller 5, and the selective heating by the print head 6.

The CPU 30 determines whether the print head 6 is currently being driven (S4). In a case where the print head 6 is being driven (yes at S4), the CPU 30 refers to the table 40 and executes threshold value decision processing, during the execution of the print processing, that determines the control threshold value Th1 used in the motor control processing, based on at least the component temperature T2 (S5). At S5, the control threshold value Th1 is calculated in accordance with the following Formula (1).

$$Th 1 = α \times T 3 + β + γ \times ( T 2 - T 3 ) \qquad Formula ( 1 )$$

In a case where the print head 6 is not being driven (no at S4), the CPU 30 refers to the table 40 and determines, during the execution of the print processing, the control threshold value Th1 used in the motor control processing, based on at least the component temperature T2 (S6). The processing at S6 is the threshold value decision processing. At step S6, the control threshold value Th1 is calculated in accordance with the following Formula (2). Formula (2) is a calculation formula that further subtracts σ from the calculation formula shown in Formula (1). In other words, σ is a variable for taking into consideration the fact that heat generation by the print head 6 is smaller when the print head 6 is not being driven, compared to when the print head 6 is being driven.

$$Th 1 = α \times T 3 + β + γ \times ( T 2 - T 3 ) - σ \qquad Formula ( 2 )$$

Subsequent to the processing at S5 and S6, the CPU 30 determines whether the motor temperature T1 detected by the first temperature sensor 71 is greater than the control threshold value Th1 (S7). In a case where the motor temperature T1 is greater than the control threshold Th1 (yes at S7), based on at least the motor temperature T1 and the component temperature T2, the CPU 30 reduces the rotation speed of the transport motor 53 during the execution of the print processing to reduce a rise in the motor temperature T1 (S8). Specifically, in a case where the motor temperature T1 is greater than the control threshold value Th1 during the execution of the print processing, the CPU 30 reduces the rotation speed of the transport motor 53. More specifically, through the motor control processing, the CPU 30 stops the driving of the transport motor during the execution of the print processing.

The CPU 30 refers to the table 40 and calculates the re-start threshold value Th2 (S9). The re-start threshold value Th2 is a value smaller than the control threshold value Th1, and is calculated in accordance with the following Formula (3). Formula (3) is a calculation formula that further subtracts n1 from the calculation formula shown in Formula (1). n1 is set to a value greater than σ, taking into consideration an appropriate value of the motor temperature T1. In Formula (1) to Formula (3), the value of (T2−T3) is the temperature difference obtained by subtracting the ambient temperature T3 from the component temperature T2.

$$Th 2 = α \times T 3 + β + γ \times ( T 2 - T 3 ) - n 1 \qquad Formula ( 3 )$$

The CPU 30 determines whether the motor temperature T1 detected by the first temperature sensor 71 is smaller than the re-start threshold value Th2 (S10). In a case where the motor temperature T1 is not smaller than the re-start threshold value Th2 (no at S10), the CPU 30 returns the processing to S9. In a case where the motor temperature T1 has become smaller than the re-start threshold value Th2 (yes at S10), the CPU 30 outputs a control signal to the motor driver 38 and the drive circuit 37, in accordance with the print data included in the print command acquired at S1. The transport motor 53 and the print head 6 re-start the driving based on the control signal, and re-start the printing on the medium P (S11). The printer 1 repeats the transport of the medium P by the predetermined amount by the transport roller 5, and the selective heating by the print head 6. In a case where the motor temperature T1 is not larger than the control threshold value Th1 (no at S7), or subsequent to S11, the CPU 30 determines whether the print processing based on the print command acquired at S1 is to be ended (S12). In a case where the print processing is to be ended (yes at S12), the CPU 30 returns the processing to S1. In a case where the print processing is not to be ended (no at S12), the CPU 30 returns the processing to S4.

In a case where it is the component non-driving time (no at S2), the CPU 30 outputs a control signal to the motor driver 38 and the drive circuit 37 in accordance with the print data included in the print command acquired at S1. The transport motor 53 and the print head 6 are driven based on the control signal, and the print processing that prints the print image on the medium P is started (S20).

The CPU 30 determines whether it is the head driving time, which is the time at which the print head 6 is being driven (S21). In a case where it is the head driving time (yes at S21), the CPU 30 executes the threshold value decision processing, during the execution of the print processing, to determine the control threshold value Th3 to be used in the motor control processing based on at least the component temperature T2 (S22). At S22, the CPU 30 acquires the ambient temperature T3 output by the third temperature sensor 41, refers to a formula stored in the table 40, and calculates the control threshold value Th3 at the head driving time. The control threshold value Th3 is calculated in accordance with the following Formula (4), for example.

$$Th 3 = α \times T 3 + β \qquad Formula ( 4 )$$

In a case where it is the head non-driving time (no at S21), during the execution of the print processing, the CPU 30 determines the control threshold value Th3 used in the motor control processing based on at least the component temperature T2 (S23). The processing at S23 is the threshold value decision processing. At S23, the CPU 30 acquires the ambient temperature T3 output by the third temperature sensor 41, refers to a formula stored in the table 40, and calculates the control threshold value Th3 at the head non-driving time. The control threshold value Th3 is calculated in accordance with the following Formula (5), for example. In a similar manner to Formula (2), Formula (5) is a calculation formula that further subtracts σ from the calculation formula shown in Formula (4). As shown in Formula (4) and Formula (5), when the components are not being driven, in contrast to when the components are being driven, the CPU 30 determines the control threshold value Th3 based on the ambient temperature T3 without using the component temperature T2.

$$Th 3 = α \times T 3 + β - σ \qquad Formula ( 5 )$$

Subsequent to the processing at S22 and S23, the CPU 30 determines whether the motor temperature T1 detected by the first temperature sensor 71 is greater than the control threshold value Th3 (S24). In a case where the motor temperature T1 is greater than the control threshold value Th3 (yes at S24), the CPU 30 performs processing at S25. The CPU 30 reduces the rotation speed of the transport motor 53 during the execution of the print processing, based on at least the motor temperature T1 to reduce a rise in the motor temperature T1 (S25). In a case where the motor temperature T1 is greater than the control threshold value Th3 during the execution of the print processing, the CPU 30 reduces the rotation speed of the transport motor 53. More specifically, through the motor control processing, the CPU 30 stops the driving of the transport motor 53 during the execution of the print processing.

The CPU 30 refers to the table 40 and calculates the re-start threshold value Th4 (S26). The re-start threshold value Th4 is a value smaller than the control threshold value Th3, and is calculated in accordance with the following Formula (6), for example. Formula (6) is a calculation formula that further subtracts n2 from the calculation formula shown in Formula (4). n2 is set to a value greater than σ, taking into consideration an appropriate value of the motor temperature T1. As shown in Formula (6), at the component non-driving time, in contrast to the component driving time, the CPU 30 determines the re-start threshold value Th4 based on the ambient temperature T3, without using the component temperature T2. n1 and n2 may be mutually different variables, or may the same variable as each other.

$$Th 4 = α \times T 3 + β - n 2 \qquad Formula ( 6 )$$

The CPU 30 determines whether the motor temperature T1 detected by the first temperature sensor 71 is smaller than the re-start threshold value Th4 (S27). In a case where the motor temperature T1 is not smaller than the re-start threshold value Th4 (no at S27), the CPU 30 returns the processing to S26. In a case where the motor temperature T1 is smaller than the re-start threshold value Th4 (yes at S27), the CPU 30 outputs a control signal to the motor driver 38 and the drive circuit 37 in accordance with the print data included in the print command acquired at S1. The transport motor 53 and the print head 6 are driven in accordance with the control signal, and the printing on the medium P is re-started (S28). The printer 1 repeats the transport of the medium P by the predetermined amount by the transport roller 5, and the selective heating by the print head 6. In a case where the motor temperature T1 is not greater than the control threshold value Th3 (no at S24), or subsequent to S28, the CPU 30 determines whether the print processing based on the print command acquired at S1 is to be ended (S29). In a case where the print processing is to be ended (yes at S29), the CPU 30 returns the processing to S1. In a case where the print processing is not to be ended (no at S29), the CPU 30 returns the processing to S21. In a case where the CPU 30 detects an end command to end the main processing, the CPU 30 ends the main processing.

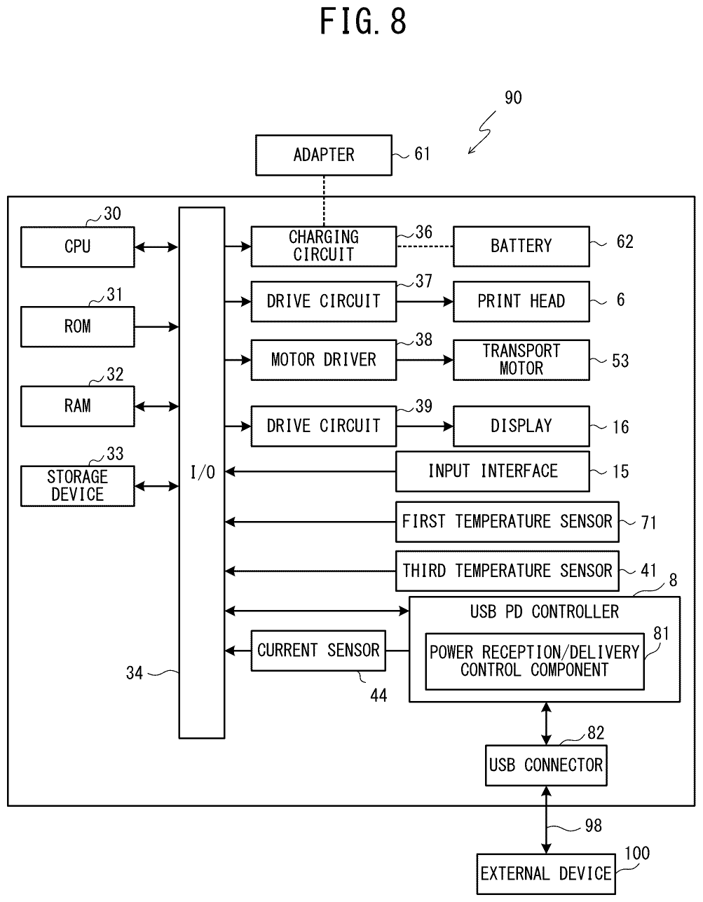

A printer 90 according to a first modified example will be described with reference to FIG. 8 to FIG. 11B. The electrical configuration of the printer 90 according to the first modified example will be described with reference to FIG. 8. In FIG. 8, the same reference signs are assigned to the configuration that is the same as that of the printer 1 according to the above-described embodiment. As shown in FIG. 8, the printer 90 according to the first modified example differs from the printer 1 according to the above-described embodiment in that the printer 90 does not include the second temperature sensor 72, and includes a current sensor 44. The storage device 33 of the printer 90 according to the first modified example is configured to store a table 45 in place of the table 40. A description will be omitted of the configuration that is the same as that of the printer 1, and the current sensor 44 and the table 45 that differ from the printer 1 will be described.

The current sensor 44 is configured to detect a magnitude of a current during the power reception or the power delivery by the power reception/delivery control component 81. In other words, the current sensor 44 is configured to detect the magnitude of the current between the power reception/delivery control component 81 and the external device 100. The current sensor 44 is configured to detect the magnitude of the current flowing along a signal line connecting the power reception/delivery control component 81 and the USB PD controller 8. The current sensor 44 may be configured to detect the current using a magnetic field generated by a current flowing in a conductor. The current sensor 44 may be a Hall IC sensor, a film coil sensor, or an MR (Magneto Resistance) element sensor, for example.

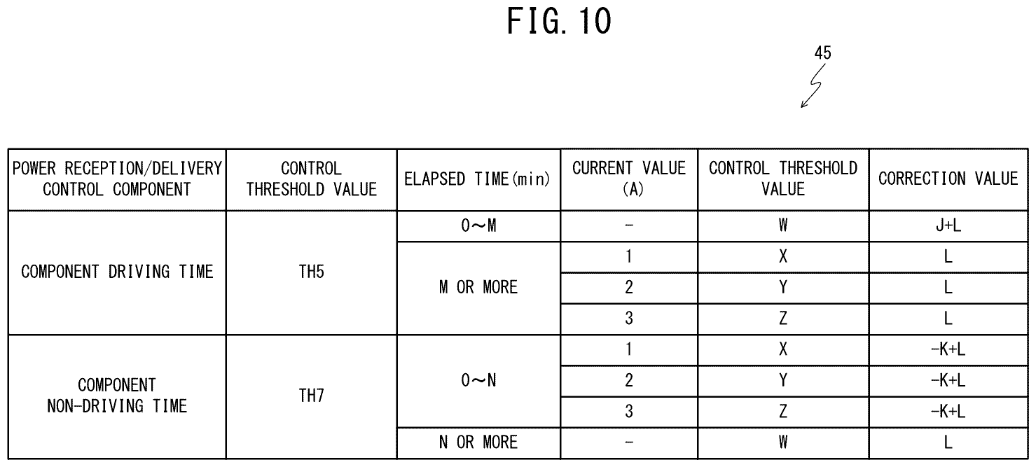

As shown in FIG. 10, the table 45 stores control threshold values Th5 and Th7, and a correction value CV. The control threshold values Th5 and Th7 are used to determine whether to perform the motor control processing. The motor control processing is the processing that, in order to reduce the overheating of the transport motor 53, lowers the rotation speed of the transport motor 53 during the execution of the print processing to reduce a rise in the motor temperature T1. The control threshold value Th5 is a control threshold value at the component driving time. The control threshold value Th7 is a control threshold value at the component non-driving time. Each of W, X, Y, and Z is a control threshold value corresponding to the magnitude of the current output by the current sensor 44 and a predetermined elapsed time. The predetermined elapsed time is an elapsed time from a start or a stopping of the power reception or the power delivery by the power reception/delivery control component 81 with the external device 100.

The correction value CV is a correction value corresponding to whether it is the component driving time in which the power reception or the power delivery by the power reception/delivery control component 81 with the external device 100 is being executed. The correction value CV is used in processing to compare the control threshold value Th5 or the control threshold value Th7 with the motor temperature T1 while taking into consideration the influence of the heat generated by the use of the power reception/delivery control component 81. L is a correction value that takes the ambient temperature T3 into consideration. Lis a value obtained by subtracting a normal ambient temperature T4 from the ambient temperature T3. The normal ambient temperature T4 may be set as appropriate while taking into consideration the temperature of the environment in which the printer 90 is normally used, and may be 25° C., for example.

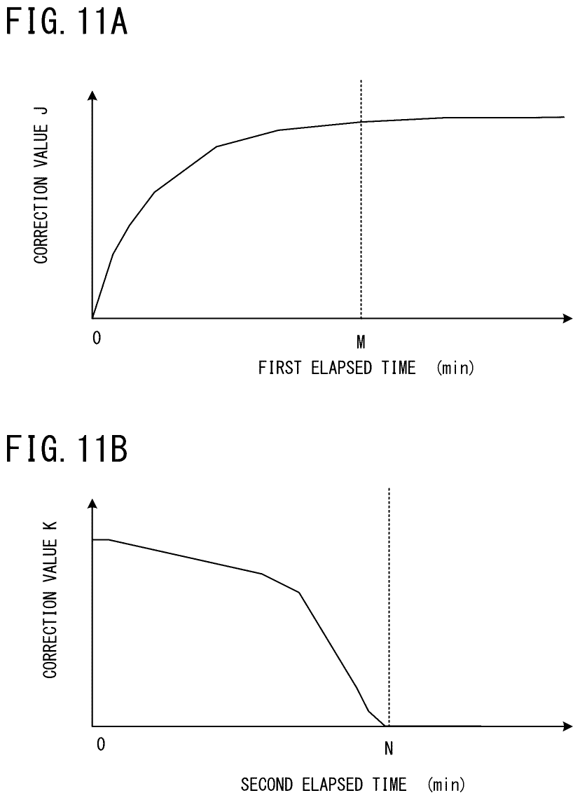

J is a correction value set in accordance with a first elapsed time, which is the elapsed time from the start of the power reception or the power delivery by the power reception/delivery control component 81 with the external device 100. As shown in FIG. 11A, the storage device 33 stores a correspondence between the first elapsed time and the correction value J. The correspondence between the first elapsed time and the correction value J may be stored in a table using numerical values, or may be stored using a mathematical formula. The CPU 30 determines J in accordance with the first elapsed time.

K is a correction value set in accordance with a second elapsed time, which is the elapsed time from the stopping of the power reception or the power delivery by the power reception/delivery control component 81 with the external device 100. As shown in FIG. 11B, the storage device 33 stores a correspondence between the second elapsed time and the correction value K. The correspondence between the second elapsed time and the correction value K may be stored in a table using numerical values, or may be stored using a mathematical formula. The CPU 30 determines K in accordance with the second elapsed time.

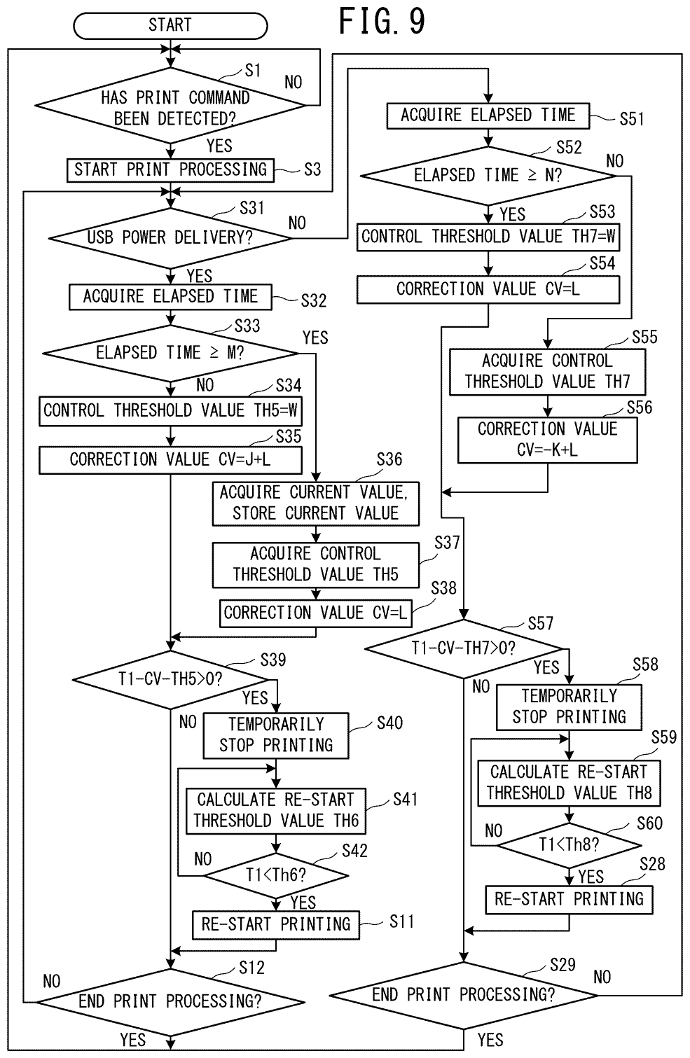

Main processing executed by the printer 90 according to the first modified example will be described with reference to FIG. 9 to FIG. 11B. Hereinafter, “step” will be abbreviated as “S”. After the power source is turned ON, the CPU 30 reads out, to the RAM 32, the program stored in the ROM 31. The program includes instructions for the CPU 31 to perform the following processes. In accordance with the instructions included in the program read out to the RAM 32, the CPU 30 executes the main processing that includes the following steps. Various data obtained in the course of the main processing are stored in the RAM 32 as appropriate.

In FIG. 9, the same step number is assigned to the processing that is the same as that of the main processing of the printer 1 according to the above-described embodiment. A description of the processing that is the same as that of the main processing of the printer 1 will be simplified or omitted. As shown in FIG. 9, in a case where the print command has been detected (yes at S1), the CPU 30 starts the print processing (S3). The CPU 30 determines whether it is the component driving time (S31). In a case where it is the component driving time (yes at S31), the CPU 30 acquires the first elapsed time from the start of the power reception or the power delivery by the power reception/delivery control component 81 with the external device 100 (S32). The CPU 30 according to the first modified example measures the first elapsed time in processing executed separately from the main processing.

The CPU 30 determines whether the first elapsed time is equal to or greater than M (S33). In a case where the power reception/delivery control component 81 starts the power reception or the power delivery with the external device 100, heat is generated by the use of the power reception/delivery control component 81. Mis set as appropriate while taking into consideration a time period taken for a temperature change of the power reception/delivery control component 81 to become constant, from the start of the power reception or the power delivery by the power reception/delivery control component 81 with the external device 100. M may be set in advance, or may be set by the user.

In a case where the CPU 30 determines that the first elapsed time is not equal to or greater than M (no at S33), the CPU 30 performs processing at S34. The CPU 30 refers to the table 45, and sets W, which corresponds to the condition that the first elapsed time is not equal to or greater than M, as the control threshold value Th5 at the component driving time (S34). The CPU 30 refers to the table 45, and sets a value obtained by adding L to J, which corresponds to the condition that the first elapsed time is not equal to or greater than M, as the correction value CV (S35). The CPU 30 determines J by referring to the correspondence between the first elapsed time and the correction value J shown in FIG. 11A.

In a case where the CPU 30 determines that the first elapsed time is equal to or greater than M (yes at S33), the CPU 30 acquires the magnitude of the current output by the current sensor 44, and stores the acquired current in the RAM 32 (S36). The CPU 30 refers to the table 45, and executes threshold value determination processing that determines the control threshold value Th5 during the print processing, based on at least the magnitude of the current (S37). In a case where the magnitude of the current output by the current sensor 44 is 1 A, the CPU 30 sets X as the control threshold value Th5. In a case where the magnitude of the current output by the current sensor 44 is 2 A, the CPU 30 sets Y as the control threshold value Th5. In a case where the magnitude of the current output by the current sensor 44 is 3 A, the CPU 30 sets Z as the control threshold value Th5. Y is larger than X and smaller than Z. In other words, the larger the magnitude of the current output by the current sensor 44, the larger the control threshold value. The CPU 30 refers to the table 45, and sets L, which corresponds to the condition that the first elapsed time is equal to or greater than M, as the correction value CV (S38).

After S35 or S38, the CPU 30 determines whether a value obtained by subtracting the correction value CV and the control threshold value Th5 from the motor temperature T1 is greater than zero (S39). The processing at S39 is the same as processing that determines whether the motor temperature T1 corrected using the correction value CV is greater than the control threshold value Th5. The processing at S39 is the same as processing that determines whether the motor temperature T1 is greater than the control threshold value Th5 corrected using the correction value CV.

In a case where the CPU 30 determines that the value obtained by subtracting the correction value CV and the control threshold value Th5 from the motor temperature T1 is greater than zero (yes at S39), the CPU 30 performs processing at S40. The CPU 30 reduces the rotation speed of the transport motor 53 during the execution of the print processing to reduce a rise in the motor temperature T1 (S40). Specifically, the CPU 30 decelerates or stops the transport motor 53. The CPU 30 according to the first modified example stops the driving of the transport motor 53 during the execution of the print processing.

The CPU 30 calculates a re-start threshold value Th6 (S41). The re-start threshold value Th6 is a value smaller than the control threshold value Th5, and is calculated in accordance with the following Formula (7). Formula (7) is a calculation formula that further subtracts n1 from the control threshold value Th5. n1 may be the same as n1 of the above-described embodiment, or may be different from n1 of the above-described embodiment.

$$Th 6 = Th 5 - n 1 \qquad Formula ( 7 )$$

The CPU 30 determines whether the motor temperature T1 detected by the first temperature sensor 71 is smaller than the re-start threshold value Th6 (S42). In a case where the CPU 30 determines that the motor temperature T1 is not smaller than the re-start threshold value Th6 (no at S42), the CPU 30 returns the processing to S41. In a case where the CPU 30 determines that the motor temperature T1 is smaller than the re-start threshold value Th6 (yes at S42), the CPU 30 performs the processing at S11. The CPU 30 outputs a control signal to the motor driver 38 and the drive circuit 37, in accordance with the print data included in the print command acquired at S1. The transport motor 53 and the print head 6 re-start the driving based on the control signal, and re-start the printing on the medium P (S11).

The CPU 30 determines whether the print processing based on the print command acquired at S1 is to be ended (S12). The CPU 30 determines that the print processing is to be ended in a case where the printing of a print image represented by the print data included in the print command is complete. In a case where the CPU 30 determines that the print processing is to be ended (yes at S12), the CPU 30 returns the processing to S1. In a case where the CPU 30 determines that the print processing is not to be ended (no at S12), the CPU 30 returns the processing to S31.

In a case where the CPU 30 determines that it is the component non-driving time (no at S31), the CPU 30 performs processing at S51. The CPU 30 acquires the second elapsed time from the stopping of the power reception or power delivery by the power reception/delivery control component 81 with the external device 100 (S51). The CPU 30 according to the first modified example measures the second elapsed time in processing executed separately from the main processing.

The CPU 30 determines whether the second elapsed time from the stopping of the power reception or the power delivery by the power reception/delivery control component 81 with the external device 100 is equal to or greater than N (S52). In a case where the power reception/delivery control component 81 stops the power reception or the power delivery with the external device 100, the generation of the heat by the use of the power reception/delivery control component 81 is stopped, and the temperature of the power reception/delivery control component 81 decreases. N is set as appropriate while taking into consideration a time period taken for the temperature change of the power reception/delivery control component 81 to become constant, from the stopping of the power reception or the power delivery by the power reception/delivery control component 81 with the external device 100. N may be set in advance, or may be set by the user.

In a case where the CPU 30 determines that the second elapsed time is equal to or greater than N (yes at S52), the CPU 30 performs processing at S53. The CPU 30 refers to the table 45, and sets W, which corresponds to the condition that the second elapsed time is equal to or greater than N, as the control threshold value Th7 at the component non-driving time (S53). The CPU 30 refers to the table 45, and sets the value L, which corresponds to the condition that the second elapsed time is equal to or greater than N, as the correction value CV (S54).

In a case where the CPU 30 determines that the second elapsed time is not equal to or greater than N (no at S52), the CPU 30 performs processing at S55. The CPU 30 executes the threshold value determination processing that determines the control threshold value Th7, based on the magnitude of the current stored in the RAM 32 and the table 45 (S55). The magnitude of the current stored in the RAM 32 is the value stored by the processing at S36. In a case where the magnitude of the current stored in the RAM 32 is 1 A, the CPU 30 sets X as the control threshold value Th7. In a case where the magnitude of the current stored in the RAM 32 is 2 A, the CPU 30 sets Y as the control threshold value Th7. In a case where the magnitude of the current stored in the RAM 32 is 3 A, the CPU 30 sets Z as the control threshold value Th7. The CPU 30 refers to the table 45, and sets a value of −K in addition to L, which corresponds to the condition that the second elapsed time is not equal to or greater than N, as the correction value CV (S56).

After S54 or S56, the CPU 30 determines whether a value obtained by subtracting the correction value CV and the control threshold value Th7 from the motor temperature T1 is greater than zero (S57). In a case where the CPU 30 determines that the value obtained by subtracting the correction value CV and the control threshold value Th7 from the motor temperature T1 is greater than zero (yes at S57), the CPU 30 performs processing at S58. The CPU 30 reduces the rotation speed of the transport motor 53 during the execution of the print processing to reduce a rise in the motor temperature T1 (S58). Specifically, the CPU 30 decelerates or stops the transport motor 53. The CPU 30 according to the first modified example stops the driving of the transport motor 53 during the execution of the print processing.

The CPU 30 calculates a re-start threshold value Th8 (S59). The re-start threshold value Th8 is a value smaller than the control threshold value Th7, and is calculated in accordance with the following Formula (8). Formula (8) is a calculation formula that further subtracts n2 from the control threshold value Th7. n2 may be the same as n2 of the above-described embodiment, or may be different from n2 of the above-described embodiment.

$$Th 8 = Th 7 - n 2 \qquad Formula ( 8 )$$

The CPU 30 determines whether the motor temperature T1 detected by the first temperature sensor 71 is smaller than the re-start threshold value Th8 (S60). In a case where the CPU 30 determines that the motor temperature T1 is not smaller than the re-start threshold value Th8 (no at S60), the CPU 30 returns the processing to S59. In a case where the CPU 30 determines that the motor temperature T1 is smaller than the re-start threshold value Th8 (yes at S60), the CPU 30 performs the processing at S28. The CPU 30 outputs a control signal to the motor driver 38 and the drive circuit 37, in accordance with the print data included in the print command acquired at S1. The transport motor 53 and the print head 6 re-start the driving based on the control signal, and re-start the printing on the medium P (S28).

The CPU 30 determines whether the print processing based on the print command acquired at S1 is to be ended (S29). In a case where the CPU 30 determines that the print processing is to be ended (yes at S29), the CPU 30 returns the processing to S1. In a case where the CPU 30 determines that the print processing is not to be ended (no at S29), the CPU 30 returns the processing to S31. In a case where the CPU 30 detects the end command to end the main processing, the CPU 30 ends the main processing.

A second modified example will be described in which, in the main processing executed by the printer 1 according to the above-described embodiment, the control threshold value is a constant value. The printer 1 according to the second modified example has the same configuration as the printer 1 according to the above-described embodiment. In the main processing shown in FIG. 6, the CPU 30 according to the second modified example uses (α× T3+β) as the control threshold value in Formula (1) to Formula (6), for example, and uses a value other than (α×T3+β) as the correction value. In other words, the control threshold value Th1 according to the above-described embodiment corresponds to a value obtained by correcting the control threshold value according to the second modified example using the correction value. At S5 and S6, the CPU 30 executes correction value determination processing that determines the correction value based on at least the component temperature T2 during the execution of the print processing and at the component driving time. The correction value determined at S5 is {γ×(T2−T3)}. The correction value determined at S6 is {γ×(T2−T3)−σ}. At S7, the CPU 30 determines whether a value obtained by subtracting the correction value and the control threshold value from the motor temperature T1 during the execution of the print processing and at the component driving time is greater than zero. In a case where the CPU 30 determines that the value obtained by subtracting the correction value and the control threshold value from the motor temperature T1 during the execution of the print processing and at the component driving time is greater than zero (yes at S7), the CPU 30 performs the processing at S8. The CPU 30 decelerates or stops the transport motor 53 (S8).

In the above embodiment, the first modified example, and second modified example, the second substrate 4 is one example of the “second substrate” of the present disclosure. The transport roller 5 is one example of the “transport roller” of the present disclosure. The print head 6 is one example of the “print head” of the present disclosure. The first substrate 7 is one example of the “first substrate” of the present disclosure. The CPU 30 is one example of the “processor” of the present disclosure. The motor driver 38 is one example of the “motor driver” of the present disclosure. The third temperature sensor 41 is one example of the “third temperature sensor” of the present disclosure. The transport motor 53 is one example of the “transport motor” of the present disclosure. The first temperature sensor 71 is one example of the “first temperature sensor” of the present disclosure. The second temperature sensor 72 is one example of the “second temperature sensor” of the present disclosure. The power reception/delivery control component 81 is one example of the “power reception/delivery control component” of the present disclosure. The printer 1 is one example of the “printer” of the present disclosure. The printer 90 is one example of the “printer” of the present disclosure. The first direction E1 is one example of the “first direction” of the present disclosure. The second direction E2 is one example of the “second direction” of the present disclosure.

The printer 1 according to the above-described embodiment includes the transport roller 5, the transport motor 53, the motor driver 38, the print head 6, the first temperature sensor 71, the power reception/delivery control component 81, the second temperature sensor 72, and the CPU 30. The transport roller 5 is configured to transport the medium P. The transport motor 53 is configured to drive the transport roller 5. The motor driver 38 is configured to drive the transport motor 53. The print head 6 is configured to print on the medium P. The first temperature sensor 71 is configured to detect the motor temperature T1 corresponding to the temperature of at least one selected from a group of the transport motor 53 and the motor driver 38. The power reception/delivery control component 81 is configured to execute power reception, power delivery, or both power reception and power delivery. The second temperature sensor 72 is configured to detect the component temperature T2 corresponding to the temperature of the power reception/delivery control component 81. The CPU 30 drives the transport motor 53 and the print head 6, and executes the print processing (S3 and S20) that prints on the medium P. The CPU 30 reduces the rotation speed of the transport motor 53 during the execution of the print processing, based on at least the motor temperature T1 and the component temperature T2, and executes the motor control processing that reduces the rise in the motor temperature T1 (S8 to S11, and S25 to S28). The motor control processing of the printer 1 reduces the rotation speed of the transport motor 53 during the execution of the print processing, based on at least the motor temperature T1 and the component temperature T2. Thus, compared to a printer of related art that controls the rotation speed of the transport motor 53 without basing the control on the component temperature, the printer 1 contributes to appropriately executing the temperature control of the transport motor 53, even when heat is generated as a result of using the power reception/delivery control component 81.

During the execution of the print processing, the CPU 30 executes the threshold value decision processing that determines the control threshold value Th1 used in the motor control processing based on at least the component temperature T2 (S5 and S6). In the motor control processing, during the execution of the print processing, in the case where the motor temperature T1 is greater than the control threshold value Th1 (yes at S7), the CPU 30 reduces the rotation speed of the transport motor 53 (S8). The threshold value decision processing of the printer 1 contributes to appropriately executing the temperature control of the transport motor 53, while taking into consideration an influence when the heat is generated as a result of using the power reception/delivery control component 81, compared to a case in which the control threshold value Th1 is determined without being based on the component temperature T2.

The printer 1 includes the third temperature sensor 41 configured to detect the ambient temperature T3 corresponding to the temperature of the surrounding atmosphere of the printer 1. In the threshold value decision processing, the CPU 30 determines the control threshold value Th1 based on at least the component temperature T2 and the ambient temperature T3. The threshold value decision processing of the printer 1 contributes to appropriately executing the temperature control of the transport motor 53, while taking into consideration an influence of the component temperature T2 and the ambient temperature T3 also when the heat is generated as a result of using the power reception/delivery control component 81, compared to a case in which the control threshold value Th1 is determined without being based on the component temperature T2 and the ambient temperature T3.

In the threshold value decision processing, the CPU 30 determines the control threshold value Th1 based on the temperature difference obtained by subtracting the ambient temperature T3 from the component temperature T2 (S5 and S6). By determining the control threshold value Th1 using the temperature difference, the threshold value decision processing of the printer 1 contributes to appropriately executing the temperature control of the transport motor 53, while taking into consideration an influence of a temperature corresponding to an amount of heat generated as a result of using the power reception/delivery control component 81.

In the threshold value decision processing, at the component non-driving time (no at S2), the CPU 30 determines the control threshold value Th3 based on the ambient temperature T3 (S22 and S23). The component non-driving time is the time at which the power reception/delivery control component 81 is not performing the power reception and the power delivery with the external device 100. In the threshold value decision processing, at the component driving time (yes at S2), the CPU 30 determines the control threshold value Th1 based on the component temperature T2 and the ambient temperature T3 (S5 and S6). The component driving time is the time at which the power reception/delivery control component 81 is performing the power reception and power delivery with the external device 100. The threshold value decision processing of the printer 1 contributes to appropriately executing the temperature control of the transport motor 53, while taking into consideration a drive situation of the power reception/delivery control component 81, compared to a case in which the same control threshold value Th1 is used at each of the component non-driving time and the component driving time.

In the threshold value decision processing, the CPU 30 determines the control threshold value Th1 at the component non-driving time and the control threshold value Th1 at the component driving time, as the mutually different values (S5, S6, S22, and S23). The component non-driving time is the time at which the power reception/delivery control component 81 is not performing the power reception and the power delivery with the external device 100. The component driving time is the time at which the power reception/delivery control component 81 is performing the power reception and the power delivery with the external device 100. The threshold value decision processing of the printer 1 contributes to appropriately executing the temperature control of the transport motor 53, while taking into consideration the drive situation of the power reception/delivery control component 81, compared to a case in which the same control threshold value Th1 is used both at the component non-driving time and at the component driving time.

In the threshold value decision processing, the CPU 30 determines the control threshold value Th1 at the head non-driving time and the control threshold value Th1 at the head driving time, as the mutually different values (S5, S6). In the threshold value decision processing, the CPU 30 determines the control threshold value Th3 at the head non-driving time and the control threshold value Th3 at the head driving time, as the mutually different values (S22, S23). The head non-driving time is the time at which the print head 6 is not being driven. The head driving time is the time at which the print head 6 is being driven. The threshold value decision processing of the printer 1 contributes to appropriately executing the temperature control of the transport motor 53, while taking into consideration a drive situation of the print head 6, compared to a case in which the same control threshold value Th1 is used both at the head non-driving time and at the head driving time.

In the motor control processing, the CPU 30 stops the driving of the transport motor 53 during the execution of the print processing (S8, S25). By stopping the driving of the transport motor 53, the motor control processing of the printer 1 contributes to reducing the rise in the motor temperature T1 to a maximum extent.

During the execution of the print processing, the CPU 30 executes the threshold value decision processing that determines the control threshold value Th1 based on at least the component temperature T2 (S5 and S6). In the case where, during the execution of the print processing, the CPU 30 determines, by the motor control processing, that the motor temperature T1 is greater than the control threshold value Th1 (yes at S7), the CPU 30 stops the transport motor 53 (S8). In the case where the motor temperature T1 has become smaller than the re-start threshold value Th2 that is smaller than the control threshold value Th1 (yes at S10), the CPU 30 re-starts the driving of the transport motor 53 (S11). The motor control processing of the printer 1 contributes to both reducing the rise in the motor temperature T1 and to executing the print processing to the end.

The printer 1 includes the first substrate 7 on which the power reception/delivery control component 81 and the motor driver 38 are mounted. The first substrate 7 of the printer 1 contributes to simplifying a configuration of the printer 1, compared to a case in which the power reception/delivery control component 81 and the motor driver 38 are mounted on separate substrates.

The first temperature sensor 71 is mounted on the first substrate 7 and is configured to detect the motor temperature T1 corresponding to the temperature of the motor driver 38, and the second temperature sensor 72 is mounted on the first substrate 7. The first substrate 7 of the printer 1 contributes to simplifying the configuration of the printer 1, compared to a case in which the motor driver 38, the power reception/delivery control component 81, the first temperature sensor 71, and the second temperature sensor 72 are mounted on separate substrates.

The first distance D1 between the first temperature sensor 71 and the motor driver 38 is 10 mm or less, and the distance D2 between the second temperature sensor 72 and the power reception/delivery control component 81 is 10 mm or less. The first temperature sensor 71 of the printer 1 contributes to appropriately detecting the motor temperature T1, compared to a case in which the first distance D1 is greater than 10 mm. The second temperature sensor 72 of the printer 1 contributes to appropriately detecting the component temperature T2, compared to a case in which the distance D2 is greater than 10 mm.

The printer 1 includes the third temperature sensor 41 mounted on the second substrate 4 different from the first substrate 7, and that detects the ambient temperature T3 corresponding to the temperature of the surrounding atmosphere of the printer 1. In the motor control processing, the CPU 30 reduces the motor temperature T1 by reducing the driving of the transport motor 53 based on at least the motor temperature T1, the component temperature T2, and the ambient temperature T3. The second substrate 4 and the third temperature sensor 41 of the printer 1 contribute to detecting, as the ambient temperature T3, an atmospheric temperature that is less likely to be influenced by the heat generated as a result of the use of the motor driver 38 and the power reception/delivery control component 81. The motor control processing of the printer 1 contributes to appropriately executing the temperature control of the transport motor 53 while taking into consideration the influence of the component temperature T2 and the ambient temperature T3, even when heat is generated as a result of the use of the power reception/delivery control component 81, compared to a case in which the control threshold value Th1 is determined without being based on the component temperature T2 and the ambient temperature T3.

In the direction perpendicular to the largest surfaces 74 and 75 of the first substrate 7 or the largest surfaces 42 and 43 of the second substrate 4, the first substrate 7 is disposed in the first direction E1 in relation to the print head 6. The second substrate 4 is disposed in the second direction E2, which is opposite to the first direction E1, in relation to the print head 6. With the printer 1, the first substrate 7 and the second substrate 4, a distance in the first direction E1 between the first substrate 7 and the second substrate 4 can be increased, compared to a case in which the first substrate 7 and the second substrate 4 are positioned in the same direction in relation to the print head 6. The second substrate 4 and the third temperature sensor 41 of the printer 1 contribute to detecting, as the ambient temperature T3, the atmospheric temperature that is less likely to be influenced by the heat generated as a result of the use of the motor driver 38 and the power reception/delivery control component 81.

The power reception/delivery control component 81 is at least one selected from a group of the DCDC converter, the charging circuit, and the inductor. The printer 1 contributes to appropriately executing the temperature control of the transport motor 53 while taking into consideration the influence of the heat generated by the use of at least one selected from a group of the DCDC converter, the charging circuit, and the inductor.

The printer 90 according to the first modified example includes the transport roller 5, the transport motor 53, the motor driver 38, the print head 6, the first temperature sensor 71, the power reception/delivery control component 81, and the CPU 30. The transport roller 5 is a roller configured to transport the medium P. The transport motor 53 is configured to drive the transport roller 5. The motor driver 38 is configured to drive the transport motor 53. The print head 6 is configured to print on the medium P. The first temperature sensor 71 is configured to detect the motor temperature T1. The motor temperature T1 is the temperature having the correlation with the temperature of the transport motor 53 or the motor driver 38, or with both the transport motor 53 and the motor driver 38. The power reception/delivery control component 81 is configured to execute power reception, power delivery, or both power reception and power delivery. The CPU 30 executes the print processing and the motor control processing. The print processing is the processing to drive the transport motor 53 and the print head 6 and print on the medium P (S3). The motor control processing is the processing that, in the case where the value obtained by subtracting the correction value CV and the control threshold value Th5 from the motor temperature T1 is greater than zero (yes at S39), decelerates or stops the transport motor 53 during the execution of the print processing to reduce a rise in the motor temperature T1 (S40). The motor control processing is the processing that, in the case where the value obtained by subtracting the correction value CV and the control threshold value Th7 from the motor temperature T1 is greater than zero (yes at S57), decelerates or stops the transport motor 53 during the execution of the print processing to reduce a rise in the motor temperature T1 (S58). The correction value CV is the value corresponding to whether it is the component driving time at which the power reception/delivery control component 81 is executing the power reception or the power delivery with the external device 100. Compared to a case of the known printer that controls the transport motor 53 without using the correction value CV, the motor control processing of the printer 90 contributes to appropriately executing the temperature control of the transport motor 53 while taking into consideration the heat generated by the use of the power reception/delivery control component 81.

The CPU 30 of the printer 90 according to the first modified example executes the correction value determination processing. The correction value determination processing is the processing that determines the correction value CV based on at least the elapsed time from the start or the stopping of the power reception or the power delivery by the power reception/delivery control component 81 with the external device 100 during the execution of the print processing (S35, S38, S54, S56). In the motor control processing, when the value obtained by subtracting the correction value CV and the control threshold value from the motor temperature T1 during the execution of the print processing is greater than zero (yes at S39, yes at S57), the CPU 30 decelerates or stops the transport motor 53 (S40, S58). Compared to a case of a printer that determines the correction value CV without taking into consideration the elapsed time from the start or stopping of the power reception or the power delivery by the power reception/delivery control component 81 with the external device 100, the correction value determination processing of the printer 90 contributes to appropriately executing the temperature control of the transport motor 53 while taking into consideration the heat generated by the use of the power reception/delivery control component 81.

The printer 90 according to the first modified example includes the current sensor 44 configured to detect the magnitude of the current the magnitude of the current during the power reception or the power delivery by the power reception/delivery control component 81. The CPU 30 executes the threshold value determination processing (S37) that determines the control threshold value Th5 based on at least the magnitude of the current during the execution of the print processing. In the motor control processing, in the case where the value obtained by subtracting the correction value CV and the control threshold value Th5 from the motor temperature T1 during the execution of the print processing is greater than zero (yes at S39), the CPU 30 decelerates or stops the transport motor 53 (S40). Compared to a case of a printer that determines a control threshold value without taking into consideration the magnitude of the current when the power reception/delivery control component 81 executes the power reception or the power delivery with the external device 100, the threshold value determination processing of the printer 90 contributes to appropriately executing the temperature control of the transport motor 53 while taking into consideration the heat generated by the use of the power reception/delivery control component 81.

The first temperature sensor 71 of the printer 1 according to the second modified example is disposed at the first position at which the distance between the first temperature sensor 71 and the transport motor 53 or the motor driver 38 is 10 mm or less. The first temperature sensor 71 is configured to detect the temperature detected at the first position as the motor temperature T1. The printer 1 includes the second temperature sensor 72. The second temperature sensor 72 is disposed at the second position at which the distance between the second temperature sensor 72 and the power reception/delivery control component 81 is 10 mm or less. The second temperature sensor 72 detects the temperature detected at the second position as the component temperature T2 that has the correlation with the temperature of the power reception/delivery control component 81. The CPU 30 executes the correction value determination processing (S5 and S6) that determines the correction value CV based on at least the component temperature T2 during the execution of the print processing and at the component driving time. In the motor control processing, in the case where the value obtained by subtracting the correction value CV and the control threshold value from the motor temperature T1 during the execution of the print processing and at the component driving time is greater than zero (yes at S7), the CPU 30 decelerates or stops the transport motor 53 (S8). Compared to a case of a printer that determines the correction value CV without taking the component temperature T2 into consideration, the threshold value determination processing of the printer 1 contributes to appropriately executing the temperature control of the transport motor 53 while taking into consideration the heat generated by the use of the power reception/delivery control component 81.

The printer 90 according to the first modified example includes the third temperature sensor 41 configured to detect the ambient temperature T3 having the correlation with the temperature of the surrounding atmosphere of the printer 90. The first temperature sensor 71 is disposed at the first position at which the first distance D1 between the first temperature sensor 71 and the transport motor 53 or the motor driver 38, which are the motor-related components, is 10 mm or less. The first temperature sensor 71 is configured to detect the temperature detected at the first position as the motor temperature T1. The third temperature sensor 41 is disposed at the third position at which the second distance between the third temperature sensor 41 and the motor-related component is greater than the first distance D1. The third temperature sensor 41 is configured to detect the temperature detected at the third position as the ambient temperature T3. The CPU 30 executes the correction value determination processing that determines the correction value CV based on at least the ambient temperature T3 during the execution of the print processing. In the motor control processing, in the case where the value obtained by subtracting the correction value CV and the control threshold value from the motor temperature T1 during the execution of the print processing is greater than zero, the printer 90 decelerates or stops the transport motor 53. Compared to a case of a printer that determines the correction value CV without taking the ambient temperature T3 into consideration, the threshold value determination processing of the printer 90 contributes to appropriately executing the temperature control of the transport motor 53.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below:

The present disclosure can be executed in various formats, and may be realized, for example, by a print program executed by a processor of a printer, a non-transitory computer-readable medium storing the print program, and a control method of the printer.

(A) The configuration of the printer 1 may be changed as appropriate. The printer 1 may include a cutting mechanism configured to cut the medium P, or may omit the cutting mechanism appropriately. The type of the printer 1 may be changed as appropriate, and the printer 1 may be an inkjet printer, or a label printer. The position of the transport roller 5 may be changed as appropriate in accordance with the configuration of the print head 6, and may be located at a different position from a position facing the print head 6. The printer 1 may include a plurality of the transport rollers 5. The printer 1 may include a plurality of the first temperature sensors 71 corresponding to the number of the transport rollers 5. The number of first temperature sensors 71 may be less than the number of transport rollers 5. The medium P may be changed as appropriate, and may be a tape that is not wound into a roll shape, or may be fanfold paper. The type and the arrangement, for example, of each of the first temperature sensor 71, the second temperature sensor 72, and the third temperature sensor 41 may be changed as appropriate. The first temperature sensor 71 may detect the motor temperature T1 corresponding to the temperature of the transport motor 53. The third temperature sensor 41 may be changed as appropriate, and may acquire the ambient temperature from an external device, such as a smartphone, for example. The second temperature sensor 72 may be omitted as appropriate.

It is sufficient that the power reception/delivery control component 81 according to the above-described embodiment is configured to execute at least one of the power reception or the power delivery with the external device 100. The power reception/delivery control component 81 is not limited to the component that performs the USB PD power delivery to the USB device. More specifically, it is sufficient that the power reception/delivery control component 81 be a component that influences the motor temperature by causing a rise in temperature due to the driving of the power reception/delivery control component 81. Thus, the power reception/delivery control component 81 may be, for example, a component that performs power delivery to the external device 100 from the printer 1 using a non-contact power delivery technology. The power reception/delivery control component 81 may be the charging circuit, and the inductor, in addition to the DCDC converter. The printer 1 may include a plurality of types of the power reception/delivery control component 81, or a plurality of the same component. In a case where the printer 1 includes the plurality of the power reception/delivery control components 81, the printer 1 may include a plurality of the second temperature sensors 72 corresponding to the number of the power reception/delivery control components 81. The number of second temperature sensors 72 may be less than the number of power reception/delivery control components 81. For example, in the above-described embodiment, the printer 1 may use the charging circuit 36 as a power reception/delivery control component. The printer 1 may use each of a charging circuit and a DCDC converter as a power reception/delivery control component.

In the above-described embodiment, the case is described in which the printer 1 executes the motor control processing based on the detection results of the three temperature sensors, namely, the first temperature sensor 71, the second temperature sensor 72, and the third temperature sensor 41. The printer 1 may execute the motor control processing based on detection results of four or more temperature sensors. In a case where the printer 1 executes the motor control processing based on the four or more temperature sensors, calculation formulas may be set by changing the parameters of the formulas exemplified in the table 40. The types and content of the formulas stored in the table 40 are examples, and may be changed as appropriate. The configurations and arrangement of the first substrate 7 and the second substrate 4 may be changed, or omitted as appropriate. The first substrate 7 and the second substrate 4 may be disposed such that the largest surface 74 and the largest surface 42 are substantially parallel to each other, or may be disposed such that the largest surface 74 and the largest surface 42 intersect or are orthogonal to each other. In the direction perpendicular to the largest surface 74 of the first substrate 7 and the largest surface 42 of the second substrate 4, the first substrate 7 and the second substrate 4 may be disposed in the same direction as each other in relation to the print head 6. In the direction perpendicular to the largest surface 42 of the second substrate 4, the first substrate 7 may be disposed in a first direction in relation to the print head 6, and the second substrate 4 may be disposed in a second direction opposite to the first direction, in relation to the print head 6.

(B) It is sufficient that the program including the instructions for executing the main processing shown in FIG. 6 is stored in a storage device of the printer 1 until the CPU 30 executes the program. It is sufficient that the program including the instructions for executing the main processing shown in FIG. 9 is stored in a storage device of the printer 90 until the CPU 30 executes the program. Thus, each of an acquisition method of the program, an acquisition path, and a device that stores the program may be changed as appropriate. The program executed by the CPU 30 may be received from another device via a cable or via wireless communication, and stored in the storage device. The other device includes a PC, and a server connected via a network, for example.

(C) Each of the steps of the main processing is not limited to the example of being executed by the CPU 30, and some or all of the steps may be executed by another electronic device, such as an ASIC, for example. Each of the steps of the main processing may be executed by distributed processing by a plurality of electronic devices, such as a plurality of CPUs, for example. In other words, a processor of the printer 1 may be a plurality of electronic devices. With respect to each of the steps of the main processing, an order of the each of the steps may be changed, a step may be omitted, or a step may be added, as appropriate. The following changes may be added to the main processing as appropriate. The term “processor” encompasses both a single processor or a group of multiple processors located either locally or remotely working together or in a distributed fashion to collectively perform the tasks attributed to the “processor” described herein.

It is sufficient that the control threshold value Th1 calculated at S5 and S6 is calculated based on at least the component temperature T2, and a variable and a calculation formula may be changed as appropriate. The control threshold value calculated at S5 and S6 may be determined based on the component temperature T2 and the ambient temperature T3, such as a sum of the component temperature T2 and the ambient temperature T3, for example. The CPU 30 may determine the control threshold value Th1 not based on the temperature difference obtained by subtracting the ambient temperature T3 from the component temperature T2. The control threshold value Th1 and the re-start threshold value Th2 may be calculated using the same calculation formula both at the component non-driving time and at the component driving time. The CPU 30 may omit the processing at S4 and S6, and may calculate the control threshold value Th1 using the same calculation formula, regardless of whether the print head 6 is being driven. The same calculation formula may be the calculation formula used at S5 or S6, and may be another calculation formula. In a similar manner, the CPU 30 may omit the processing at S21 and S23, and may calculate the control threshold value Th3 using the same calculation formula, regardless of whether the print head 6 is being driven.

In the printer 90 according to the first modified example, the control threshold value need not necessarily be determined based on the magnitude of the current when the power reception/delivery control component 81 performs the power reception or the power delivery with the external device 100. The CPU 30 may determine the correction value CV based on the magnitude of the current when the power reception/delivery control component 81 performs the power reception or the power delivery with the external device 100. The correction value CV need not necessarily be determined based on the elapsed time from the start or the stopping of the power reception or the power delivery by the power reception/delivery control component 81 with the external device 100.

The above-described embodiment and modified examples may be combined as appropriate insofar as no contradictions arise. In addition to combinations exemplified in the scope of the claims herein, the applicants of the present application have an intention to acquire the patent rights for other combined aspects insofar as they do not depart from the scope and gist of the present disclosure, and insofar as no contradictions arise.

What is claimed is:

1. A printer comprising:
a transport roller;
a transport motor configured to drive the transport roller;
a motor driver configured to drive the transport motor;
a print head;
a first temperature sensor configured to detect a motor temperature corresponding to a temperature of the transport motor, the motor driver, or both the transport motor and the motor driver;
a power reception/delivery control component configured to execute power reception, power delivery, or both power reception and power delivery;
a second temperature sensor configured to detect a component temperature corresponding to a temperature of the power reception/delivery control component; and
a processor configured to execute:
driving the transport motor and the print head to perform printing on a medium; and
reducing a rotation speed of the transport motor during the printing, based on at least the motor temperature and the component temperature, to reduce a rise in the motor temperature.

2. The printer according to claim 1, wherein
the processor is further configured to execute:
determining a control threshold value used in reducing the rotation speed based on at least the component temperature during the printing, and
the reducing the rotation speed includes reducing the rotation speed of the transport motor in a case where the motor temperature is greater than the control threshold value during the printing.

3. The printer according to claim 2, further comprising:
a third temperature sensor configured to detect an ambient temperature corresponding to a temperature of a surrounding atmosphere of the printer, wherein
the determining the control threshold value includes determining the control threshold value based on at least the component temperature and the ambient temperature.

4. The printer according to claim 3, wherein
the determining the control threshold value includes determining the control threshold value based on a temperature difference obtained by subtracting the ambient temperature from the component temperature.

5. The printer according to claim 3, wherein
the determining the control threshold value includes
determining the control threshold value based on the ambient temperature at a component non-driving time being a time at which the power reception/delivery control component is not performing the power reception and the power delivery, and
determining the control threshold value based on the component temperature and the ambient temperature at a component driving time being a time at which the power reception/delivery control component is performing the power reception or the power delivery with an external device.

6. The printer according to claim 2, wherein
the determining the control threshold value includes
determining, as mutually different values, the control threshold value at a component non-driving time being a time at which the power reception/delivery control component is not performing the power reception and the power delivery with an external device, and the control threshold value at a component driving time being a time at which the power reception/delivery control component is performing the power reception or the power delivery with the external device.

7. The printer according to claim 2, wherein
the determining the control threshold value includes
determining, as mutually different values, the control threshold value at a head non-driving time being a time at which the print head is not being driven, and the control threshold value at a head driving time being a time at which the print head is being driven.

8. The printer according to claim 1, wherein
the reducing the rotation speed includes stopping the driving of the transport motor during the printing.

9. The printer according to claim 1, wherein
the processor is further configured to execute:
determining a control threshold value based on at least the component temperature during the printing, and
the reducing the rotation speed includes
stopping the transport motor in a case where, during the printing, the motor temperature becomes greater than the control threshold value, and
re-starting the driving of the transport motor in a case where the motor temperature becomes lower than a re-start threshold value smaller than the control threshold value.

10. The printer according to claim 1, further comprising:
a first substrate on which the power reception/delivery control component and the motor driver are mounted.

11. The printer according to claim 10, wherein
the first temperature sensor is mounted on the first substrate, and detects the motor temperature corresponding to the temperature of the motor driver, and
the second temperature sensor is mounted on the first substrate.

12. The printer according to claim 11, wherein
a distance between the first temperature sensor and the motor driver is 10 mm or less, and
a distance between the second temperature sensor and the power reception/delivery control component is 10 mm or less.

13. The printer according to claim 10, further comprising:
a third temperature sensor mounted on a second substrate different from the first substrate, and configured to detect an ambient temperature corresponding to a temperature of a surrounding atmosphere of the printer, wherein
the reducing the rotation speed includes reducing the motor temperature by reducing driving of the transport motor, based on at least the motor temperature, the component temperature, and the ambient temperature.

14. The printer according to claim 13, wherein
in a direction perpendicular to a largest surface of the first substrate or a largest surface of the second substrate,
the first substrate is disposed in a first direction in relation to the print head, and
the second substrate is disposed in a second direction opposite to the first direction in relation to the print head.

15. The printer according to claim 1, wherein
the power reception/delivery control component is at least one selected from a group of a DCDC converter, a charging circuit, and an inductor.

16. A printer comprising:
a transport roller;
a transport motor configured to drive the transport roller;
a motor driver configured to drive the transport motor;
a print head;
a first temperature sensor configured to detect a motor temperature, the motor temperature being a temperature having a correlation with a temperature of the transport motor or the motor driver, or with a temperature of both the transport motor and the motor driver;
a power reception/delivery control component configured to execute power reception, power delivery, or both power reception and power delivery; and
a processor configured to execute:
driving the transport motor and the print head to perform printing on a medium; and
decelerating or stopping the transport motor during the printing, in a case where a value obtained by subtracting a correction value and a control threshold value from the motor temperature is greater than zero, to reduce a rise in the motor temperature, the correction value corresponding to whether it is a component driving time, the component driving time being a time at which the power reception/delivery control component is performing the power reception or the power delivery with an external device.

17. The printer according to claim 16, wherein
the processor is further configured to execute:
determining the correction value based on at least an elapsed time from a start or a stopping of the power reception or the power delivery by the power reception/delivery control component with the external device during the printing, and
the decelerating or stopping the transport motor includes decelerating or stopping the transport motor during the printing, in the case where the value obtained by subtracting the correction value and the control threshold value from the motor temperature is greater than zero.

18. The printer according to claim 16, further comprising:
a current sensor configured to detect a magnitude of a current during the power reception or the power delivery by the power reception/delivery control component, wherein
the processor is further configured to execute:
determining the control threshold value based on at least the magnitude of the current during the printing, and
the decelerating or stopping the transport motor includes decelerating or stopping the transport motor during the printing, in the case where the value obtained by subtracting the correction value and the control threshold value from the motor temperature is greater than zero.

19. The printer according to claim 16, further comprising:
a second temperature sensor disposed at a second position at which a distance between the second temperature sensor and the power reception/delivery control component is 10 mm or less, the second temperature sensor being configured to detect a temperature detected at the second position as a component temperature having a correlation with a temperature of the power reception/delivery control component, wherein
the first temperature sensor is disposed at a first position at which a distance between the first temperature sensor and the transport motor or the motor driver is 10 mm or less, and the first temperature sensor is configured to detect a temperature at the first position as the motor temperature,
the processor is further configured to execute:
determining the correction value based on at least the component temperature during the printing and at the component driving time, and
the decelerating or stopping the transport motor includes decelerating or stopping the transport motor during the printing and at the component driving time, in the case where the value obtained by subtracting the correction value and the control threshold value from the motor temperature is greater than zero.

20. The printer according to claim 16, further comprising:
a third temperature sensor configured to detect an ambient temperature having a correlation with a temperature of a surrounding atmosphere of the printer, wherein
the first temperature sensor is disposed at a first position at which a first distance between the first temperature sensor and the transport motor or the motor driver is 10 mm or less, the transport motor and the motor driver being a motor-related component, and the first temperature sensor is configured to detect a temperature at the first position as the motor temperature,
the third temperature sensor is disposed at a third position at which a second distance between the third temperature sensor and the motor-related component is larger than the first distance, and the third temperature sensor is configured to detect a temperature detected at the third position as the ambient temperature,
the processor is further configured to execute:
determining the correction value based on at least the ambient temperature during the printing, and
the decelerating or stopping the transport motor includes decelerating or stopping the transport motor during the printing, in the case where the value obtained by subtracting the correction value and the control threshold value from the motor temperature is greater than zero.
